(19) United States
(12) Patent Application Publication
(10) Pub. No.: US 2004/0155478 A1
(43) Pub. Date: Aug. 12, 2004

(54) Actuation device for movable parts on a vehicle

(76) Inventors: Gerhard Huber, Frankenhofen (DE); Alexander Svanidze, Memmingen (DE)

Correspondence Address: Dykema Gossett PLLC, Suite 300 West, 1300 I Street, N.W., Washington, DC, 20005-3306, US

(21) Appl. No.: 10/772,351

(22) Filed: Feb. 6, 2004

(30) Foreign Application Priority Data
Feb. 12, 2003 (AT) A 210/2003

(51) Int. Cl. B60J 5/10; B62D 25/10

(52) U.S. Cl. 296/76; 296/146.8; 180/69.21

(57) ABSTRACT

An actuation arrangement for movable parts on a vehicle, especially for trunk lids, rear hatches, hoods or the like, including at least one main support bracket (2) fastened to the vehicle, one hinge (3), one lever (1) connected to the movable part, which is swivably mounted to the hinge (3) in the main support bracket (2), and a driving device (4) coupled to said lever (1) with one of its ends to introduce a moment of rotation whereby a rigid extension piece (5) extends from the main support bracket (2) that is engaged by the opposite end of the driving device (4). Only the main support bracket (2) is fastened to the vehicle itself so that introduction of forces of the actuation arrangement into the vehicle body is avoided at simple and compact construction.

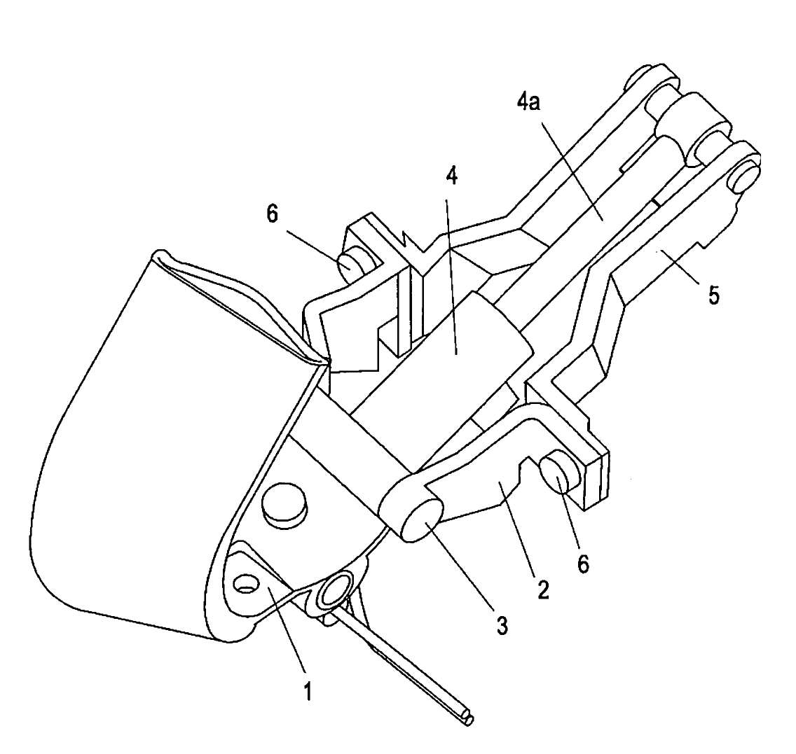

### BACKGROUND OF THE INVENTION

1. Field of the Invention

The invention relates to an actuation arrangement for movable parts on a vehicle, especially for trunk lids, rear hatches, hoods or the like, including at least one main support bracket fastened to the vehicle, one hinge, one lever connected to the movable part which is swivably mounted to the hinge in the main support bracket, and a driving device coupled to the lever with one of its ends to introduce a moment of rotation whereby a rigid extension piece extends from the main support bracket that is engaged by the opposite end of the driving device.

2. The Prior Art

Driving means are employed between the vehicle body and the part of the vehicle to be moved in traditional actuation arrangements, especially for trunk lids, rear hatches or the like. The coupling point of the driving device on the vehicle body is stressed thereby to a high degree and the body has to be reinforced in the region of the coupling point. Often times, freedom in design is thereby restricted—or there are coupling points provided by building up the vehicle body whereby, however, the possibilities for the construction of the system consisting of the rear hatch and the associated actuation device are limited.

EP 959 212 A1 discloses an actuation arrangement whereby a movable part is coupled to the vehicle by means of a multi-jointed hinge and whereby the movable part can be automatically actuated by a driving device. In one embodiment, the driving device is mounted between a lever and a hinge whereby the lever leads from the interior of the vehicle to the exterior hinge lever of the multi-jointed hinge.

U.S. 2002/0076313 A1 describes a lift for wheelchairs whereby the platform for the wheelchair can be folded up on the vehicle into a vertical position. A linear drive is provided for this motion which engages the platform, on one side, and the extension piece extending from the rotational axis, on the other side. This extension piece is coupled via a separate coupling arrangement to the support structure of the platform during the time of execution of the rotating movement when the actuation forces act upon the extension piece so that the forces are introduced into the support structure.

It was the object of the present invention to overcome the disadvantages of the aforementioned arrangement in terms of construction and force introduction and to improve the actuation arrangement in such a manner that introduction of forces from the actuation arrangement into the vehicle body can be avoided through a simple and compact construction.

### SUMMARY OF THE INVENTION

This object is achieved in that only the main support bracket is fastened to the vehicle body. A compact arrangement is thereby established in which all forces and moments are absorbed within the arrangement during automatic actuation of the movable part on the vehicle and whereby the vehicle body has to carry only the weight of the actuation arrangement and that of the movable part.

The construction of the aforementioned actuation arrangement is especially simple if the extension piece is designed as being one piece together with the main support bracket.

One embodiment of the invention simplifies the assembly, particularly the installation of the driving device into the arrangement, wherein the extension piece is designed as a separate part connected to the main support bracket.

An advantageous embodiment of the invention proposes that the extension piece is designed in the form of a link extending parallel at both sides of the driving device between the main support bracket and the far end of the driving device. Twisting and uneven stress relative to the actuation arrangement are thereby reliably avoided.

The driving device is preferably designed as a hydraulic working cylinder, which allows simple and operationally reliable integration of the actuation arrangement into the systems of the vehicle as well as easy and flexible control.

According to one preferred embodiment, the bottom of the working cylinder is connected to the lever and the piston rod is connected to the extension piece.

The object is also achieved through a vehicle with a vehicle body having at least one swivably-connected movable part, especially a trunk lid, a rear hatch, a hood or the like, whereby the movable part can be automatically rotated by means of an actuation arrangement which is inventively characterized in that the actuation arrangement is designed according to one of the paragraphs above.

In the following, the invention will be described with the aid of the accompanying FIGURE.

### BRIEF DESCRIPTION OF THE FIGURE

The FIGURE shows a perspective view of an actuation arrangement according to the present invention.

### DETAILED DESCRIPTION OF THE PREFERRED EMBODIMENTS

A trunk lid, a rear hatch, a hood or the like (not illustrated for simplification) is provided with a lever 1, or it is connected thereto, whereby the lever 1 is swivably mounted on a hinge 3 in a main support bracket 2 as shown in the FIGURE. A driving device, preferably designed as a hydraulic working cylinder 4, engages the lever 1 for automatic actuation of the rear hatch, or the like, for introduction of a moment of rotation.

The working cylinder 4, preferably its piston rod 4a, rests with the end opposite from the hinge 3 against a rigid extension piece 5 which

The extension piece 5 can thereby be designed in one piece together with the main support bracket 2 to make installation of the working cylinder 4 easier—or it can be designed as a separate part connected to the main support bracket 2 by means of bolts 6, for example. The bolts 6 may serve at the same time as connection elements of the main support bracket 2 to the vehicle body.

The extension piece 5 is preferably designed in the form of a link running parallel at both sides of the working cylinder 4 between the main support bracket 2 and the far end of the working cylinder 4 at optimal stability and optimal resistance to distortion.

1. An actuation arrangement for movable parts on a vehicle comprising at least one main support bracket (2) fastened to the vehicle, one hinge (3), one lever (1) connected to the movable part, which is swivably mounted to the hinge (3) in the main support bracket (2), and a driving device (4) coupled to said lever (1) with one of its ends to introduce a moment of rotation whereby a rigid extension piece (5) extends from the main support bracket (2) that is engaged by the opposite end of said driving device (4), wherein only the main support bracket (2) is fastened to the vehicle body.

2. An actuation arrangement according to claim 1, wherein the extension piece (5) is designed as being one piece together with the main support bracket (2).

3. An actuation arrangement according to claim 1, wherein the extension piece (5) is designed as a separate part connected to the main support bracket (2).

4. An actuation arrangement according to claim 1, wherein the extension piece (5) is designed in the form of a link extending parallel at both sides of the driving device (4) between the main support bracket (2) and the far end of the driving device (4).

5. An actuation arrangement according to claim 1, wherein the driving device (4) is designed as a hydraulic working cylinder.

6. An actuation arrangement according to claim 5, wherein a bottom of the working cylinder (4) is connected to the lever (1) and the piston rod (4a) is connected to the extension piece (5).

7. A vehicle with a vehicle body having at least one swivably-connected movable part, whereby said movable part can be automatically rotated by means of an actuation arrangement, wherein the actuation arrangement is designed according to claim 1.

8. A vehicle according to claim 7, wherein said movable part is a trunk lid.

9. A vehicle according to claim 7, wherein said movable part is a rear hatch.

10. A vehicle according to claim 7, wherein said movable part is a hood.
